(19) United States
(12) Patent Application Publication
(10) Pub. No.: US 2025/0197274 A1
(43) Pub. Date: Jun. 19, 2025

(54) LOW THERMAL SHRINKAGE GLASSES AND METHODS FOR PREPARING THEREOF

(71) Applicant: CAIHONG DISPLAY DEVICES CO., LTD., Xianyang (CN)

(72) Inventors: Zhao ZENG, Xianyang (CN); Jian XU, Xianyang (CN); Lihua XU, Xianyang (CN); Lingxin KONG, Xianyang (CN); Jing LAN, Xianyang (CN)

(73) Assignee: CAIHONG DISPLAY DEVICES CO., LTD., Xianyang (CN)

(21) Appl. No.: 19/006,294

(22) Filed: Dec. 31, 2024

Related U.S. Application Data
(63) Continuation-in-part of application No. PCT/CN2024/092909, filed on May 13, 2024.

(30) Foreign Application Priority Data
Dec. 18, 2023 (CN) 202311745469.3

(51) Int. Cl. C03C 3/091; C03B 19/02; C03C 4/20

(52) U.S. Cl. CPC C03C 3/091; C03B 19/02; C03C 4/20; C03C 2204/00

(57) ABSTRACT

A low thermal shrinkage glass and a method for preparing thereof are provided. A raw material of the low thermal shrinkage glass includes the following components in molar percentages: 69.64% to 71% SiO₂, 12.5% to 13.34% Al₂O₃, 0.73% to 1.68% B₂O₃, 5.6% to 5.89% MgO, 5.15% to 5.19% CaO, 1.1% to 1.2% SrO, 3.29% to 3.49% BaO, and 0.1% SnO₂.

### CROSS-REFERENCE TO RELATED APPLICATIONS

This application is a Continuation-in-part of International Application No. PCT/CN2024/092909, filed on May 13, 2024, which claims priority to Chinese Patent Application No. 202311745469.3, filed on Dec. 18, 2023, the entire contents of which are hereby incorporated by reference.

### TECHNICAL FIELD

The present disclosure relates to the technical field of preparation of photoelectric display glass, and in particular, to a low thermal shrinkage glass and a method for preparing thereof.

### BACKGROUND

With the rapid advancement of information technologies such as “Internet+”, artificial intelligence, and wearable devices, display devices, which serve as information windows, need to be flexible, thin and lightweight, energy-efficient, foldable, rollable, and capable of being oversized, among other requirements. Therefore, modern display technologies have emerged, such as liquid crystal display (LCD), organic light-emitting diode (OLED) and other traditional display technologies, as well as Mini-LED, Micro-LED and other new display technologies.

OLED display technology has characteristics of self-luminous, low-power consumption. Compared with the traditional LCD display technology, OLED can be used in substrates of any shape. Therefore, the OLED display technology has become a mainstream technology of flexible displays. Low Temperature Poly-silicon Thin Film Transistor (LTPS TFT) has a high electron mobility, capable of being made into a transistor with a smaller size and a faster electron mobility, and has advantages such as high brightness, high resolution and low power consumption. Therefore, the combination of OLED and LTPS TFT, that is, LTPS-OLED technology, meets requirements of high-resolution display on both traditional hard screens and flexible displays.

LTPS needs to be fabricated on a glass substrate for a hard LTPS-OLED screen, and OLED needs to be fabricated on a glass substrate for a flexible OLED screen. Thus, the preparation process demands that the glass substrates have a high Young's modulus, a low dimensional deformation, a low thickness variation, etc.

However, at present, during a process of overflow down draw molding of the glass substrate used for preparing a display screen, glass at a platinum baffle at a far end and a near end of both sides of a brick tip is susceptible to devitrification, leading to quality problems such as uneven thickness on both sides of the glass substrate, voids, and variations in material size. The glass substrate may even fracture, seriously affecting the continuity of production. This is because, in the process of infiltrating the overflow brick before the first sheet forming, a glassy liquid may be retained at the platinum baffle, and B₂O₃ on the surface of the retained glassy liquid may be partially volatile over time, resulting in the surface of the glassy liquid more susceptible to devitrification. Even after the sheet forming, the retained glassy liquid can not be completely covered by a new glassy liquid. Thus, after the production line running for a period of time, a glass devitrification at the platinum baffle occurs. A traditional solution is to use auxiliary heating equipment on both sides of the platinum baffle to “burn off” the glass devitrificated, melting the glass devitrificated into a glassy liquid with a low viscosity, which flows away under the influence of gravity. However, the solution is at the expense of production, and the sheet forming cannot be performed during the process of melting.

Therefore, there is a need to provide a low thermal shrinkage glass to avoid glass devitrification at the platinum baffle caused by surface volatilisation, thereby improving the product quality and the production efficiency.

### SUMMARY

One or more embodiments of the present disclosure provide a low thermal shrinkage glass. A raw material of the low thermal shrinkage glass includes the following components in molar percentages: 69.64% to 71% SiO₂, 12.5% to 13.34% Al₂O₃, 0.73% to 1.68% B₂O₃, 5.6% to 5.89% MgO, 5.15% to 5.19% CaO, 1.1% to 1.2% SrO, 3.29% to 3.49% BaO, and 0.1% SnO₂.

In some embodiments, molar percentages of MgO, CaO, BaO, SrO, B₂O₃, Al₂O₃, and SiO₂ satisfy Equation (I):

0.872*[MgO]+0.369*[CaO]+12.654*[BaO]+1.652*[SrO]+0.875*[B₂O₃]−0.778*[Al₂O₃]+0.634*[SiO₂]>0.85 (I)

[MgO], [CaO], [BaO], [SrO], [B₂O₃], [Al₂O₃], and [SiO₂] are the molar percentages of MgO, CaO, BaO, SrO, B₂O₃, Al₂O₃, and SiO₂, respectively.

In some embodiments, the sum of the molar percentages of MgO, CaO, SrO, and BaO is greater than the molar percentage of Al₂O₃.

In some embodiments, a strain point temperature of the low thermal shrinkage glass is 745° C. to 750° C.; and after heat treatment for 10 min at 600° C., a thermal shrinkage of the low thermal shrinkage glass reaches 7 ppm to 9 ppm.

In some embodiments, the low thermal shrinkage glass has a Young's modulus of 82 to 83 Gpa, and a density of 2.59 g/cm³.

In some embodiments, in a range of 25° C. to 380° C., the low thermal shrinkage glass has a coefficient of thermal expansion of 36.7·10⁻⁷ to 39.6·10⁻⁷.

In some embodiments, after corrosion for 20 min at 25° C. in a HF solution with a mass concentration of 40%, the low thermal shrinkage glass has an amount of corrosion per unit area of 4.7 mg/cm² to 4.9 mg/cm²; after corrosion for 360 min at 95° C. in a NaOH solution with a mass concentration of 5%, the low thermal shrinkage glass has the amount of corrosion per unit area of 0.29 mg/cm² to 0.33 mg/cm².

In some embodiments, the low thermal shrinkage glass has a UV transmittance of 300 nm wavelength >70% and a UV transmittance of 400 nm wavelength >90%.

In some embodiments, the low thermal shrinkage glass has an internal devitrification viscosity of 300,000 poise, a surface devitrification viscosity of 250,000 poise, and a devitrification temperature difference ≤7° C.

One or more embodiments of the present disclosure further provide a method for preparing the low thermal shrinkage glass described above, including the following steps:
weighing components of a raw material in molar percentages and mixing the components to form a mixture, the components of the raw material including: in molar percentages, 69.64% to 71% SiO₂, 12.5% to 13.34% Al₂O₃, 0.73% to 1.68% B₂O₃, 5.6% to 5.89% MgO, 5.15% to 5.19% CaO, 1.1% to 1.2% SrO, 3.29% to 3.49% BaO and 0.1% SnO₂;
melting the mixture at a high temperature to form a glassy liquid; and
molding the glassy liquid into the low thermal shrinkage glass.

In some embodiments, the high temperature is in a range of 1550° C. to 1600° C.

### BRIEF DESCRIPTION OF THE DRAWINGS

The present disclosure will be further illustrated by way of exemplary embodiments, which will be described in detail by means of drawings. These embodiments are not limited, and in these embodiments, the same numbering denotes the same structure, wherein:

FIG. 1 is a flowchart illustrating a method for preparing a low thermal shrinkage glass according to some embodiments of the present disclosure.

### DETAILED DESCRIPTION

In order to make the object, technical solution and advantages of the embodiments of the present disclosure clearer, the technical solution in the embodiments of the present disclosure will be described clearly and completely in the following in conjunction with the drawings. The embodiments described are obviously a part of the embodiments of the present disclosure, not all of the embodiments. Components of embodiments of the present disclosure generally described and illustrated in the drawings are arranged and designed in a variety of different configurations.

Thus, the following detailed description of embodiments of the present disclosure provided in the drawings is not intended to limit the scope of the present disclosure for which protection is claimed, but rather to indicate only selected embodiments of the present disclosure. Based on the embodiments in the present disclosure, all other embodiments obtained by those skilled in the art without creative labor fall within the scope of protection of the present disclosure.

It should be noted that similar labels and letters indicate similar items in the following drawings, and therefore, once an item is defined in a drawing, it does not need to be further defined and explained in subsequent drawings.

As shown in the present disclosure and in the claims, unless the context clearly suggests an exception, the terms “a”, “one”, and/or “the” do not refer specifically to the singular but also include the plural. In general, the terms “including” and “comprising” only suggest the inclusion of explicitly identified steps and elements that do not constitute an exclusive list, and a method or an apparatus also include other steps or elements.

Currently, a substrate glass used for the production of a display screen is susceptible to devitrification at the platinum baffle in the process of overflow down draw molding, resulting in bulging, uneven thickness and other problems, and even leading to glass breakage.

Embodiments of the present disclosure provide a low thermal shrinkage glass. The low thermal shrinkage glass is a glass having a low thermal shrinkage under a high temperature. A raw material of the low thermal shrinkage glass comprises the following components in molar percentages: 69.64% to 71% SiO₂, 12.5% to 13.34% Al₂O₃, 0.73% to 1.68% B₂O₃, 5.6% to 5.89% MgO, 5.15% to 5.19% CaO, 1.1% to 1.2% SrO, 3.29% to 3.49% BaO, and 0.1% SnO₂.

In some embodiments, the raw material of the low thermal shrinkage glass includes 71% SiO₂, 12.5% Al₂O₃, 0.73% B₂O₃, 5.89% MgO, 5.19% CaO, 1.1% SrO, 3.49% BaO, and 0.1% SnO₂. In some embodiments, the raw material of the low thermal shrinkage glass includes 69.64% SiO₂, 13.34% Al₂O₃, 1.68% B₂O₃, 5.6% MgO, 5.15% CaO, 1.2% SrO, 3.29% BaO, and 0.1% SnO₂. In some embodiments, the raw material of the low thermal shrinkage glass includes 70% SiO₂, 13% Al₂O₃, 1.55% B₂O₃, 5.7% MgO, 5.16% CaO, 1.1% SrO, 3.39% BaO, and 0.1% SnO₂.

The primary role of SiO₂ is to serve as a main part of a network structure of the glass. By controlling the molar percentage of SiO₂ between 69.64% and 71%, the glass can achieve the necessary viscosity for the production method without needing an excessively high temperature during the production process, while also ensuring a low density of the glass.

Al₂O₃ in the glass has two kinds of coordination state. When Al³⁺ is in an aluminum-oxygen tetrahedron [AlO₄], aluminum-oxygen tetrahedron and silica-oxygen tetrahedron form a unified network, forming a complex group of aluminum-silica-oxygen anion, so that the structure of the glass tends to be compact and a viscosity of the glass increases. When Al³⁺ is in an aluminum-oxygen octahedron [AlO₆], Al³⁺ is a network exoform, which destroys the network structure of the glass, and reduces the viscosity of the glass.

B₂O₃ reduces the viscosity of the glass under a high temperature and promotes the the glass melting. Especially in the substrate glass of OLED display screen, a high dimensional stability required for the substrate glass of OLED display screen results in an extremely high viscosity of the glass and a temperature of the melting process is subsequently increased. The molar percentage of B₂O₃ in a range of 0.73% to 1.68% is mainly to increase a strain point temperature of the glass and reduce a thermal shrinkage as well as reducing the viscosity of the glass. The lower molar percentage of B₂O₃ reduces a difference between the surface composition and the internal composition of the glass, thereby reducing a difference between the surface devitrification temperature and the interior devitrification temperature of the glass, and reducing the possibility of glass devitrification at the platinum baffle.

Alkaline-earth metal oxides (MgO, CaO, SrO and BaO) can reduce an overall viscosity of the glassy liquid, which is conducive to lowering the temperature of the production process, but a high content of the alkaline-earth metal oxides also leads to an increase in density of the glass, a decrease in the strain point temperature of the glass, and a deterioration in chemical durability of the glass. In some embodiments, the molar percentage of the alkaline-earth metal oxides is controlled in a range of 15.67%˜15.77%, which can decrease a temperature of a liquid phase production line, increase a viscosity of the liquid phase production line, and reduce devitrification temperatures in and outside of the glass and a devitrification temperature difference. The devitrification temperature difference refers to a difference between the surface devitrification temperature and the interior devitrification temperature of the glass. The lower devitrification temperature difference can effectively avoid the glass devitrification at the platinum baffle due to surface volatilisation.

In some embodiments, molar percentages of MgO, CaO, BaO, SrO, B₂O₃, Al₂O₃, and SiO₂ satisfy Equation (I):

$$0.87 {2}^{⋆} [ M g O ] + 0.36 {9}^{⋆} [ C a O ] + 12.65 {4}^{⋆} [ B a O ] + 1.65 {2}^{⋆} [ S r O ] + 0.87 {5}^{⋆} [ {B}_{2} {O}_{3} ] - {0.778}^{⋆} [ A {1}_{2} {O}_{3} ] + 0.63 {4}^{⋆} [ S i {O}_{2} ] > 0.85 \qquad ( 1 )$$

[MgO], [CaO], [BaO], [SrO], [B₂O₃], [Al₂O₃], and [SiO₂] denotes the molar percentages of MgO, CaO, BaO, SrO, B₂O₃, Al₂O₃, and SiO₂, respectively.

The quality and the property of the low thermal shrinkage glass can be optimized by adjusting the ratio of each oxide component in the low thermal shrinkage glass.

In some embodiments, the sum of the molar percentages of MgO, CaO, SrO, and BaO is greater than the molar percentage of Al₂O₃.

The sum of the molar percentages of the alkaline-earth metal oxides, MgO, CaO, SrO and BaO, is greater than the molar percentage of Al₂O₃, making Al³⁺ mainly located in the aluminum-oxygen octahedron [AlO₆], reducing the viscosity of the glass under a high temperature, and ensuring that the glass has a smaller thermal shrinkage and a higher Young's modulus.

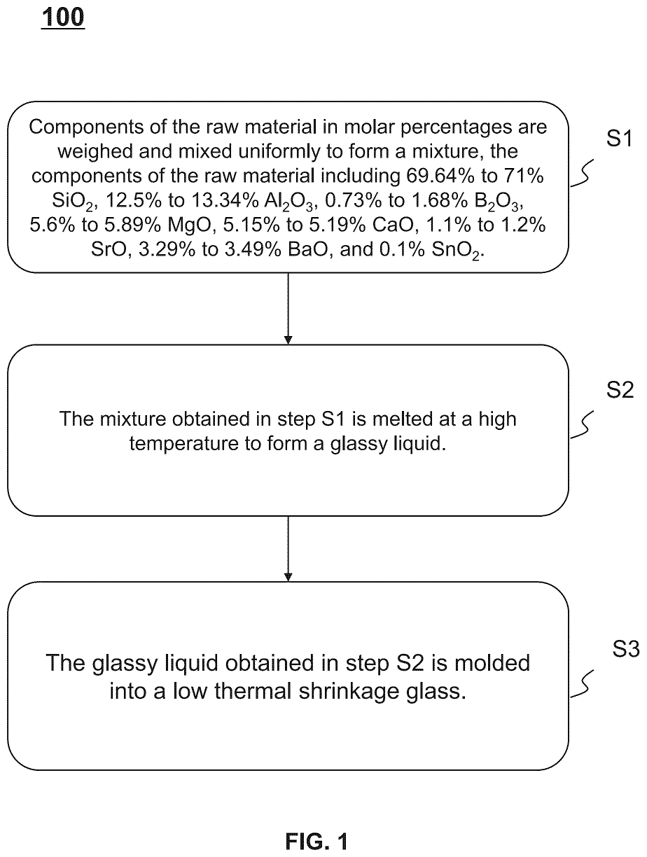

FIG. 1 is a flowchart illustrating a method for preparing a low thermal shrinkage glass according to some embodiments of the present disclosure. As shown in FIG. 1, the process 100 includes the following steps.

S1: Components of the raw material in molar percentages are weighed and mixed uniformly to form a mixture, the components of the raw material including 69.64% to 71% SiO₂, 12.5% to 13.34% Al₂O₃, 0.73% to 1.68% B₂O₃, 5.6% to 5.89% MgO, 5.15% to 5.19% CaO, 1.1% to 1.2% SrO, 3.29% to 3.49% BaO, and 0.1% SnO₂.

S2: The mixture obtained in step S1 is melted at a high temperature to form a glassy liquid.

In some embodiments, the mixture obtained in step S1 is added to a glass furnace via a feeder, and the glass furnace melts the mixture into the glassy liquid. In some embodiments, the high temperature is in a range of 1550° C. to 1600° C. In some embodiments, the high temperature is in a range of 1550° C. In some embodiments, the high temperature is in a range of 1600° C.

S3: The glassy liquid obtained in step S2 is molded into a low thermal shrinkage glass.

In some embodiments, the glassy liquid is introduced into a platinum channel for clarification and overflow down draw molding is performed to obtain the low thermal shrinkage glass.

In some embodiments, a strain point temperature of the low thermal shrinkage glass is in a range of 745° C. to 750° C. The strain point temperature is a temperature at which the glass changes from a solid state to a flowing state during heating. In some embodiments, the strain point temperature of the low thermal shrinkage glass is 745° C., 748° C., or 750° C.

In some embodiments, after heat treatment for 10 min at 600° C., a thermal shrinkage of the low thermal shrinkage glass reaches 7 ppm to 9 ppm. In some embodiments, after the heat treatment for 10 min at 600° C., the thermal shrinkage of the low thermal shrinkage glass reaches 7 ppm, 8 ppm, or 9 ppm.

In some embodiments, the low thermal shrinkage glass has a Young's modulus of 82 Gpa to 83 Gpa. In some embodiments, the low thermal shrinkage glass has a Young's modulus of 82 Gpa, 82.5 Gpa, or 83 Gpa. In some embodiments, the low thermal shrinkage glass has a density of 2.59 g/cm³.

In some embodiments, in a range of 25° C. to 380° C., the low thermal shrinkage glass has a coefficient of thermal expansion of 36.7·10⁻⁷ to 39.6·10⁻⁷.

In some embodiments, after crrosion for 20 min at 25° C. in a HF solution with a mass concentration of 40%, the low thermal shrinkage glass has an amount of corrosion per unit area of 4.7 to 4.9 mg/cm². In some embodiments, after corrosion for 20 min at 25° C. in the HF solution with the mass concentration of 40%, the low thermal shrinkage glass has an amount of corrosion per unit area of 4.7 mg/cm², 4.8 mg/cm², or 4.9 mg/cm². In some embodiments, after corrosion for 360 min at 95° C. in a NaOH solution with a mass concentration of 5%, the low thermal shrinkage glass has an amount of corrosion per unit area of 0.29 mg/cm² to 0.33 mg/cm². In some embodiments, after corrosion for 360 min at 95° C. in the NaOH solution with the mass concentration of 5%, the low thermal shrinkage glass has an amount of corrosion per unit area of 0.29 mg/cm², 0.31 mg/cm², or 0.33 mg/cm².

In some embodiments, the low thermal shrinkage glass has a UV transmittance of 300 nm wavelength >70% and a UV transmittance of 400 nm wavelength >90%.

In some embodiments, the low thermal shrinkage glass has an internal devitrification viscosity of 300,000 poise, a surface devitrification viscosity of 250,000 poise, and a devitrification temperature difference ≤7° C.

The devitrification temperature difference of the low thermal shrinkage glass is maintained within a small range, thereby ensuring that the low thermal shrinkage glass has a good thermal stability and good transparency during manufacture and use.

In the embodiments of the present disclosure, by controlling levels of the raw material components, a low thermal shrinkage glass with a lower viscosity, a smaller thermal shrinkage and a higher modulus of elasticity is prepared. In addition, the low thermal shrinkage glass has a smaller devitrification temperature difference, thereby reducing the the possibility of devitrification at the platinum baffle, and thus the quality and stability of the glass product is guaranteed. Meanwhile, the low thermal shrinkage glass with a good chemical resistance, a high Young's modulus, a high strain point temperature, a low thermal shrinkage and a high UV transmittance meets the requirement of OLED display panels.

The present disclosure is described in detail below in conjugation with specific embodiments. The following embodiments will be helpful to those skilled in the art to further understand the present disclosure, but do not limit the present disclosure in any way. It should be noted that several adjustments and improvements can be made to those skilled in the art without departing from the idea of the present disclosure. These all fall within the scope of protection of the present disclosure.

The experimental methods used in the following embodiments are conventional, if not otherwise specified. The experimental materials used in the following embodiments are, if not otherwise specified, obtained by purchase from a conventional biochemical reagent company. It should be understood that the following embodiments are intended to better explain the present disclosure and are not intended to limit the present disclosure.

### EXAMPLES

### Example 1

In molar percentage, 71% SiO₂, 12.5% Al₂O₃, 0.73% B₂O₃, 5.89% MgO, 5.19% CaO, 1.1% SrO, 3.49% BaO, and 0.1% SnO₂ are mixed uniformly to obtain a mixture. The mixture is added into a glass furnace through a feeder, and the glass furnace is heated up to 1550° C. and melts the mixture into a glassy liquid. The glassy liquid is introduced into a platinum channel for clarification, and an overflow down draw molding is performed to obtain a low thermal shrinkage glass with a thickness of 0.1 mm.

### Example 2

In molar percentage, 69.64% SiO₂, 13.34% Al₂O₃, 1.68% B₂O₃, 5.6% MgO, 5.15% CaO, 1.2% SrO, 3.29% BaO and 0.1% SnO₂ are mixed uniformly to obtain a mixture. The mixture is added into a glass furnace through a feeder, and the glass furnace is heated up to 1550° C. and melts the mixture into a glassy liquid. The glassy liquid is introduced into a platinum channel for clarification, and an overflow down draw molding is performed to obtain a low thermal shrinkage glass with a thickness of 0.1 mm.

### Example 3

In molar percentage, 70% SiO₂, 13% Al₂O₃, 1.55% B₂O₃, 5.7% MgO, 5.16% CaO, 1.1% SrO, 3.39% BaO and 0.1% SnO₂ are mixed uniformly to obtain a mixture. The mixture is added into a glass furnace through a feeder, and the glass furnace is heated up to 1600° C. and melts the mixture into a glassy liquid. The glassy liquid is introduced into a platinum channel for clarification, and an overflow down draw molding is performed to obtain a low thermal shrinkage glass with a thickness of 0.1 mm.

A performance test is performed on low thermal shrinkage glasses prepared in Examples 1-3. Results show that a strain point temperature of the low thermal shrinkage glasses is 745° C. to 750° C.; after heat treatment for 10 min at 600° C., a thermal shrinkage of the low thermal shrinkage glasses reaches 7 ppm to 9 ppm; a Young's modulus of the low thermal shrinkage glasses is 82 Gpa to 83 Gpa; a density of the low thermal shrinkage glasses is 2.59 g/cm³; in a range of 25° C. to 380° C., a coefficient of thermal expansion of the low thermal shrinkage glasses is 36.7·10⁻⁷˜39.6·10⁻⁷; after corrosion for 20 min at 25° C. in a HF solution with a mass concentration of 40%, the low thermal shrinkage glasses have an amount of corrosion per unit area of 4.7 mg/cm² to 4.9 mg/cm²; after corrosion for 360 min at 95° C. in a NaOH solution with a mass concentration of 5%, the low thermal shrinkage glasses have an amount of corrosion per unit area of 0.29 mg/cm² to 0.33 mg/cm²; the low thermal shrinkage glasses have a UV transmittance of 300 nm wavelength >70% and a UV transmittance of 400 nm wavelength >90%; the low thermal shrinkage glasses have an internal devitrification viscosity of 300,000 poise, a surface devitrification viscosity of 250,000 poise, and a devitrification temperature difference ≤7° C.

In summary, embodiments of the present disclosure provide a low thermal shrinkage glass and a method for preparing thereof. By optimizing components of the glass, a glass substrate with good chemical resistance, a high Young's modulus, a high strain point temperature, a low thermal shrinkage, and a high UV transmittance is obtained, which meets requirements of production of OLED display screens. The low thermal shrinkage glass has a low difference between the surface devitrification temperature and the interior devitrification temperature of the glass, helping prevent the devitrification at the platinum baffle due to the surface volatilisation, thereby ensuring the product quality and production efficiency.

The foregoing is merely preferred embodiments of the present disclosure, and is not intended to impose any limitation on the technical solution of the present disclosure. It should be understood by those skilled in the art that the technical solution can also be modified and replaced in a number of simple ways, all of which also fall within the scope of protection covered by the claims, without departing from the spirit and principles of the present disclosure.

What is claimed is:

1. A low thermal shrinkage glass, wherein a raw material of the low thermal shrinkage glass comprises the following components in molar percentages: 69.64% to 71% SiO₂, 12.5% to 13.34% Al₂O₃, 0.73% to 1.68% B₂O₃, 5.6% to 5.89% MgO, 5.15% to 5.19% CaO, 1.1% to 1.2% SrO, 3.29% to 3.49% BaO, and 0.1% SnO₂.

2. The low thermal shrinkage glass according to claim 1, wherein molar percentages of MgO, CaO, BaO, SrO, B₂O₃, Al₂O₃, and SiO₂ satisfy Equation (I):
$$0.87 {2}^{⋆} [ M g O ] + 0.36 {9}^{⋆} [ C a O ] + 12.65 {4}^{⋆} [ B a O ] + 1.65 {2}^{⋆} [ S r O ] + 0.87 {5}^{⋆} [ {B}_{2} {O}_{3} ] - {0.778}^{⋆} [ A {1}_{2} {O}_{3} ] + 0.63 {4}^{⋆} [ S i {O}_{2} ] > 0.85 \qquad ( 1 )$$
wherein [MgO], [CaO], [BaO], [SrO], [B₂O₃], [Al₂O₃], and [SiO₂] denote the molar percentages of MgO, CaO, BaO, SrO, B₂O₃, Al₂O₃, and SiO₂, respectively.

3. The low thermal shrinkage glass according to claim 1, wherein the sum of the molar percentages of MgO, CaO, SrO, and BaO is greater than the molar percentage of Al₂O₃.

4. The low thermal shrinkage glass according to claim 1, wherein a strain point temperature of the low thermal shrinkage glass is in a range of 745° C. to 750° C.; and
after heat treatment for 10 min at 600° C., a thermal shrinkage of the low thermal shrinkage glass reaches 7 ppm to 9 ppm.

5. The low thermal shrinkage glass according to claim 1, wherein the low thermal shrinkage glass has a Young's modulus of 82 Gpa to 83 Gpa, and a density of 2.59 g/cm³.

6. The low thermal shrinkage glass according to claim 1, wherein in a range of 25° C. to 380° C., the low thermal shrinkage glass has a coefficient of thermal expansion of 36.7·10⁻⁷ to 39.6·10⁻⁷.

7. The low thermal shrinkage glass according to claim 1, wherein after corrosion for 20 min at 25° C. in a HF solution with a mass concentration of 40%, the low thermal shrinkage glass has an amount of corrosion per unit area of 4.7 mg/cm² to 4.9 mg/cm²; after corrosion for 360 min at 95° C. in a NaOH solution with a mass concentration of 5%, the low thermal shrinkage glass has the amount of corrosion per unit area of 0.29 mg/cm² to 0.33 mg/cm².

8. The low thermal shrinkage glass according to claim 1, wherein the low thermal shrinkage glass has a UV transmittance of 300 nm wavelength >70% and a UV transmittance of 400 nm wavelength >90%.

9. The low thermal shrinkage glass according to claim 1, wherein the low thermal shrinkage glass has an internal devitrification viscosity of 300,000 poise, a surface devitrification viscosity of 250,000 poise, and a devitrification temperature difference ≤7° C.

10. A method for preparing the low thermal shrinkage glass of claim 1, comprising:
weighing components of the raw material in molar percentages and mixing the components to form a mixture;
melting the mixture at a high temperature to form a glassy liquid; and
molding the glassy liquid into the low thermal shrinkage glass.

11. The method according to claim 9, wherein the high temperature is in a range of 1550° C. to 1600° C.

12. The method according to claim 9, wherein a strain point temperature of the low thermal shrinkage glass is in a range of 745° C. to 750° C.; and after heat treatment for 10 min at 600° C., a thermal shrinkage of the low thermal shrinkage glass reaches 7 to 9 ppm.

13. The method according to claim 9, wherein the low thermal shrinkage glass has a Young's modulus of 82 Gpa to 83 Gpa, and a density of 2.59 g/cm³.

14. The method according to claim 9, wherein in a range of 25° C. to 380° C., the low thermal shrinkage glass has a coefficient of thermal expansion of 36.7·10⁻⁷ to 39.6·10⁻⁷.

15. The method according to claim 9, wherein after corrosion for 20 min at 25° C. in a HF solution with a mass concentration of 40%, the low thermal shrinkage glass has an amount of corrosion per unit area of 4.7 mg/cm² to 4.9 mg/cm²; after corrosion for 360 min at 95° C. in a NaOH solution with a mass concentration of 5%, the low thermal shrinkage glass has the amount of corrosion per unit area of 0.29 mg/cm² to 0.33 mg/cm².

16. The method according to claim 9, wherein the low thermal shrinkage glass has a UV transmittance of 300 nm wavelength >70% and a UV transmittance of 400 nm wavelength >90%.

17. The method according to claim 9, wherein the low thermal shrinkage glass has an internal devitrification viscosity of 300,000 poise, a surface devitrification viscosity of 250,000 poise, and a devitrification temperature difference ≤7° C.
